(19) United States
(12) Patent Application Publication
(10) Pub. No.: US 2014/0325674 A1
(43) Pub. Date: Oct. 30, 2014

(54) TERMINAL APPARATUS AND METHOD FOR ADJUSTING PERMISSION FOR DRM CONTENT

(71) Applicants: INTELLECTUAL DISCOVERY CO., LTD., Seoul (KR); INKA ENTWORKS, INC., Seoul (KR)

(72) Inventor: Sungwoo LEE, Seoul (KR)

(73) Assignees: INKA ENTWORKS, INC., Seoul (KR); INTELLECTUAL DISCOVERY CO., LTD., Seoul (KR)

(21) Appl. No.: 14/264,638

(22) Filed: Apr. 29, 2014

(30) Foreign Application Priority Data
Apr. 30, 2013 (KR) 10-2013-0048361

(51) Int. Cl. G06F 21/10

(52) U.S. Cl. CPC G06F 21/105
USPC 726/27

(57) ABSTRACT

A method for adjusting permission for digital rights management (DRM) content of a terminal apparatus, the method comprising: using advertisement content included in the DRM content by using a license for the DRM content; updating advertisement content usage state information depending on the use of advertisement content; comparing the updated advertisement content usage state information with policy information regarding the use of advertisement content; and adjusting permission information for digital content included in the DRM content in the license based on the comparison result.

### CROSS-REFERENCE TO RELATED APPLICATIONS

This application claims the benefit of Korean Patent Application No. 10-2013-0048361, filed on Apr. 30, 2013, which is hereby incorporated by reference as if fully set forth herein.

### BACKGROUND

1. Field

The present invention relates to a terminal apparatus and method for adjusting permission for digital rights management (DRM) content, and more particularly, to a terminal apparatus and method for adjusting permission for digital content included in DRM content depending on a usage state of advertisement content included in DRM content.

2. Description of Related Art

In line with the advancement and popularization of computer technologies, content (books, comics, records, movies, broadcastings, newspapers, or the like) of general commercial transaction produced, kept, and managed in an analog form has been mostly digitalized.

The characteristics and advantages of digital content that quality of the original digital content is free of damage although digital content is infinitely used, digital content is easy to copy and modify, and easy to transfer and distribute within a short time using a ultra high-speed communication network although it is a large amount of work, make analog works digitalized at high speed.

However, the advantages of digital content also act as a factor violating the rights and benefits of the original author. Specifically, since a copy is identical to the original, the intent to purchase the original may be dampened and since the original is simply modified and duplicated without the consent of the author, works may be easily plagiarized. In addition, the ease in transfer and distribution makes unauthorized duplicates instantly spread through the Internet, incapacitating even legal controls.

Such negative factors may demoralize authors to weaken their intent for creating works, and thus cause hesitation of digitalization. Therefore, a technical protecting device capable of effectively managing copyright, while sufficiently saving the digital advantages of digital content, is required.

In order to protect the benefits and rights of digital content, a technique of applying DRM to digital content has emerged, and various DRM schemes have also been used.

Here, the term DRM refers to a series of techniques of preventing illegal reproduction or duplication, protecting the rights and benefits of respective subjects (content creator, a distribution dealer, a distributor, a user, a copyright holder, and the like) participating in a life cycle (i.e., creation, processing, distribution, and consumption of content) of digital content, and supporting charging and payment according to the use of digital content.

Thus, a server that provides digital content using a DRM scheme encrypts digital content and transmits the same, and a license management server transmits a license to an authorized user so that only the authorized user can play and output the digital content. Here, the license includes a digital content encryption key used for decoding the digital content, digital content permission information as information regarding the use of the digital content, and the like.

Meanwhile, in a conventional method of using DRM content including advertisement content or digital content, users must use advertisement content in order to use digital content (music, video, text, application, or the like) each time. Thus, since users have no choice but to use advertisement content to use digital content each time, users may have hostility toward corresponding advertisement content and negatively react to goods of the corresponding advertisement content

### SUMMARY

In view of the above, therefore, the present invention provides a terminal apparatus and method for adjusting permission for DRM content capable of flexibly adjusting permission for digital content included in DRM content depending on a usage state of advertisement content included in DRM content.

In accordance with the present invention, there is provided a method for adjusting permission for digital rights management (DRM) content of a terminal apparatus, the method comprising: using advertisement content included in the DRM content by using a license for the DRM content; updating advertisement content usage state information depending on the use of advertisement content; comparing the updated advertisement content usage state information with policy information regarding the use of advertisement content; and adjusting permission information for digital content included in the DRM content in the license based on the comparison result.

In the embodiment, the policy information regarding the use of advertisement content is information defining a relationship between the advertisement content usage state information and digital content permission update information.

In the embodiment, said adjusting permission information includes: detecting the digital content permission update information mapped to the updated advertisement content usage state information based on the comparison result; and using the detected digital content permission update information to adjust the permission information for digital content.

In the embodiment, the method further comprising: when the use of advertisement content included in the DRM is completed, using the license for the DRM content to use the digital content.

In accordance with the present invention, there is provided a terminal apparatus, which includes: an input unit configured to receive a usage command for digital rights management (DRM) content; a display unit configured to display advertisement content included in the DRM content when the usage command is input; and a controller configured to update advertisement content usage state information depending on the usage command, compare the updated advertisement content usage state information with policy information regarding the use of advertisement content, and adjust permission information for the digital information included in the DRM content in the license for the DRM content based on the comparison result.

In the embodiment, the policy information regarding the use of advertisement content is information defining a relationship between the advertisement content usage state information and digital content permission update information.

In the embodiment, the controller is configured to detect the digital content permission update information mapped to the updated advertisement content usage state information based on the comparison result, and use the detected digital content permission update information to adjust the permission information for digital content.

In the embodiment, the controller is configured to control the display unit to display the digital content by using the license for the DRM content when the use of advertisement content included in the DRM is completed.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of a system for adjusting permission for DRM content in accordance with an embodiment of the present invention;

FIG. 2 is a timing diagram illustrating a method for adjusting permission for DRM content in accordance with an embodiment of the present invention; and

FIG. 3 is a block diagram of a terminal apparatus for adjusting permission for DRM content in accordance with an embodiment of the present invention.

### DETAILED DESCRIPTION

Hereinafter, various embodiments of the present invention will be described in detail with the accompanying drawings.

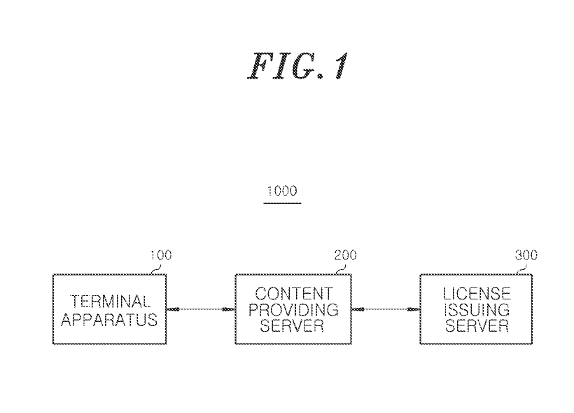

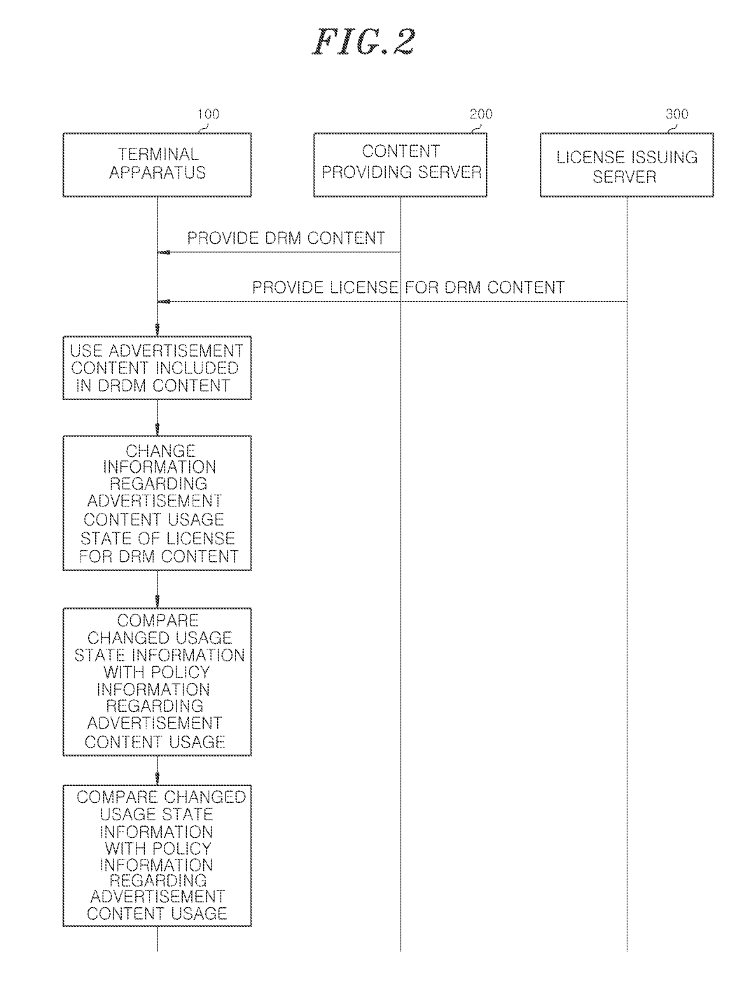

FIG. 1 is a block diagram of a system for adjusting permission for DRM content in accordance with an embodiment of the present invention, and FIG. 2 is a timing diagram illustrating a method for adjusting permission for DRM content in accordance with an embodiment of the present invention. Referring to FIGS. 1 and 2, a system 1000 includes all or a portion of a terminal apparatus 100, a content providing server 200, and a license issuing server 300.

The content providing server 200 may provide DRM content to a user. Here, the DRM content may be DRM content including advertisement content and digital content (music, video text, application, or the like) or DRM content including only digital content. Here, the advertisement content may or may not be included in DRM content based on advertisement contracts between a service provider of content providing services and an advertiser of advertisement content.

The license issuing server 300 may be a server generating and issuing a license for DRM content to be provided by the content providing server 200. Here, when DRM content includes advertisement content and digital content, the license issuing server 300 may separately issue a license for each of the advertisement content and the digital content, or may issue a single license covering both the advertisement content and the digital content.

Also, when DRM content includes advertisement content and digital content, the license issuing server 300 may issue digital content permission information and policy information regarding the use of advertisement content. Here, when digital content is movie content, the digital content permission information may be information defining permission for digital content, such as an available number of playing movie content, an available term of playing movie content, and the like.

In addition, the policy information regarding the use of advertisement content may be information defining a relationship between advertisement content usage state information and digital content permission update information.

For example, in a case where advertisement content included in DRM content is video advertisement content and digital content included in DRM content is video content, when the video advertisement content is played ten times, an available number of playing digital content included in the corresponding DRM content may be increased to five times, a usage term thereof may be lengthened three more days, or when a number of playing video advertisement content included in the DRM content reaches a maximum of thousand times, digital content included in the corresponding DRM content may be played without playing advertisement content, or the like. In this manner, the policy information regarding the use of advertisement content may be information defining a relationship between advertisement content usage state information and digital content permission update information. The relationship between advertisement content usage state information and digital content permission update information may vary depending on advertisement contracts between an advertiser of advertisement content and a content providing service provider.

Hereinafter, for the convenience of description of an embodiment of the present invention, a case where DRM content includes advertisement content and digital content will be described by way of example.

A user of the terminal apparatus 100 may access the content providing server 200, check DRM content provided by the content providing server 200, and select DRM content including advertisement content and digital content. In this case, the selected DRM content may be downloaded and stored in the terminal apparatus 100.

In addition, the terminal apparatus 100 may download a license for using the downloaded DRM content from the license issuing server 300 and store the same.

Meanwhile, when a usage command for DRM content is input, a DRM agent of the terminal apparatus 100 may first use advertisement content included in the DRM content by using the license in association with a configuration of the licensed terminal apparatus 100. Also, when the use of the advertisement content included in the DRM content is finished, the DRM agent of the terminal apparatus 100 may use the digital content included in the DRM content by using the license in association with the configuration of the terminal apparatus 100.

Meanwhile, when the use of the advertisement content included in the DRM content is completed from beginning to end, the DRM agent of the terminal apparatus 100 may increase advertisement content usage state (number) information of the license for the corresponding DRM content by one and compare the same with the policy information regarding the use of the advertisement content, in association with the configuration of the terminal apparatus 100.

If there is no digital content permission update information mapped to the advertisement usage state (number) information based on the comparison result, the DRM agent of the terminal apparatus 100 may not change the digital content permission information of the license for the corresponding DRM content.

Meanwhile, when the user of the terminal apparatus 100 uses the advertisement content included in the DRM content several times from beginning to end, the DRM agent of the terminal apparatus 100 may change the advertisement usage state (number) information of the license for the corresponding DRM content and compare the same with the policy information regarding the use of the advertisement content, in association with the configuration of the terminal apparatus 100.

If there is any digital content permission information mapped to the advertisement usage state (number) information based on the comparison result, the DRM agent of the terminal apparatus 100 may change the digital content permission information of the license for the DRM content, in association with the configuration of the terminal apparatus 100.

For example, when the policy information regarding the use of advertisement content defines that an available number of using digital content included in DRM content will be increased ten times when the number of using the advertisement content is a hundred times, the DRM agent of the terminal apparatus 100 may further increase the available number of using digital content of the license for the corresponding DRM content from a current number to 10 times, in association with the configuration of the terminal apparatus 100.

Or, when the policy information regarding the use of advertisement content defines that digital content included in DRM content may be used without the use of an advertisement when the number of using the advertisement content is a thousand times, the DRM agent of the terminal apparatus 100 may remove the use of advertisement content and a coupling element thereof in the part related to the use of digital content of the license for the corresponding DRM content, in association with the configuration of the terminal apparatus 100.

Meanwhile, the terminal apparatus 100 may display permission information of digital content changed based on advertisement usage state information and an advertisement usage state.

Here, the foregoing terminal apparatus 100 may be implemented using various devices such as a smartphone, a tablet computer, a notebook computer, a personal digital assistant (PDA), a portable multimedia player (PMP), and the like, which may use DRM content.

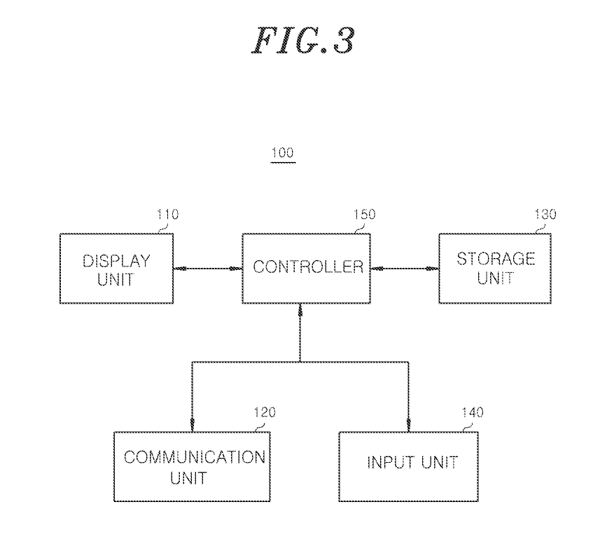

FIG. 3 is a block diagram of the terminal apparatus for adjusting permission for DRM content in accordance with an embodiment of the present invention. Referring to FIG. 3, the terminal apparatus 100 includes all or a portion of a display unit 110, a communication unit 120, a storage unit 130, an input unit 140, and a controller 150.

The display unit 110 serves to display a screen. In particular, the display unit 110 may display a screen for using DRM content including advertisement content and digital content (for example, a play screen when DRM content is video). Also, the display unit 110 may display advertisement usage state information and permission information of digital content changed based on an advertisement usage state.

Here, the display unit 110 may be implemented as at least one of a liquid crystal display, a thin film transistor-liquid crystal display, an organic light emitting diode, a flexible display, a 3D display, and a transparent display.

The communication unit 120 may allow the terminal apparatus 100 to communicate with an external device. In particular, the communication unit 120 may receive DRM content from the content providing server 200 and receive a license for the DRM content from the license issuing server 300.

Here, the communication unit 120 may be connected through a local area network (LAN) and the Internet network wirelessly or in a wired manner, connected through a universal serial bus (USB) port, connected through a mobile communication network such as 3G or 4G, or connected through a near-field communication (NFC) scheme such as NFC, radio frequency identification (RFID), Wi-Fi, or the like.

The storage unit 130 serves to store various data and programs required for operating the terminal apparatus 100. In particular, the storage unit 130 may store a DRM agent. Here, the storage unit 130 may be implemented as a detachable storage device such as a USB memory, a CD-ROM, or the like, as well as as an internal storage device such as a random access memory (RAM), a flash memory, a read-only memory (ROM), an erasable programmable ROM (EPROM), an electronically erasable and programmable ROM (EEPROM), a register, a hard disk, a removable disk, a memory card, and the like.

The input unit 140 receives a user input of operating the terminal apparatus 100. In particular, the terminal apparatus 100 may receive a DRM content usage command (for example, a play command when DRM content is video).

Here, the input unit 140 may be implemented using at least one of various buttons, a touch sensor for receiving a touch input applied to the display unit 110, a proximity sensor for receiving an approaching motion, rather than being directly in contact with a surface of the display unit 110, and a microphone for receiving a voice input of the user. However, the present invention is not limited thereto and the input unit 140 may be implemented in any form as long as it can receive a user input.

The controller 150 controls the whole operations of the terminal apparatus 100. In particular, the controller 150 may control all or a portion of the display unit 110, the communication unit 120, the storage unit 130, and the input unit 140, in association with the DRM agent stored in the storage unit 130.

Specifically, when a usage command for DRM content is input through the input unit 140, the controller 150 may first use advertisement content included in DRM content by using a license.

In addition, when the use of the advertisement content included in the DRM content is completed from beginning to end, the controller 150 may compare advertisement content usage state information of the license for the corresponding DRM content with policy information regarding the use of the advertisement content.

Then, based on the comparison result, the controller 150 may control whether to adjust digital content permission information of the license for the corresponding DRM content.

Meanwhile, when the use of the advertisement content included in the DRM content is finished, the controller 150 may use digital content included in the DRM content by using the license.

In accordance with various embodiments of the present invention as described above, users may be motivated to increasingly use advertisement content, and advertisers may have a maximized advertisement effect.

Also, user reluctance to goods of corresponding advertisement content may be resolved.

In addition, users may obtain extended permission for digital content depending on the use of advertisement content and eventually freely use content even without the use of an advertisement.

Further, since permission for digital content is flexibly adjusted based on an advertisement usage state, reasonable advertisement costs may be appropriated.

Meanwhile, the method in accordance with various embodiments of the present invention as described above may be implemented with program codes and stored in various non-transitory computer readable medium so that it can be provided to each server or equipment.

The term non-transitory readable medium as used herein refers to a medium that can semi-permanently store data and be read by a device, rather than a medium that stores temporarily data, such as a register, a cache, a memory, or the like. Specifically, various applications or programs as described above may be stored in a non-transitory readable medium, such as a CD, a DVD, a hard disk, a Blueray disk, a USB, a memory card, a ROM, or the like, and provided.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for adjusting permission for digital rights management (DRM) content of a terminal apparatus, the method comprising:
using advertisement content included in the DRM content by using a license for the DRM content;
updating advertisement content usage state information depending on the use of advertisement content;
comparing the updated advertisement content usage state information with policy information regarding the use of advertisement content; and
adjusting permission information for digital content included in the DRM content in the license based on the comparison result.

2. The method of claim 1, wherein the policy information regarding the use of advertisement content is information defining a relationship between the advertisement content usage state information and digital content permission update information.

3. The method of claim 2, wherein said adjusting permission information includes:
detecting the digital content permission update information mapped to the updated advertisement content usage state information based on the comparison result; and
using the detected digital content permission update information to adjust the permission information for digital content.

4. The method of claim 1, further comprising:
when the use of advertisement content included in the DRM is completed, using the license for the DRM content to use the digital content.

5. A terminal apparatus, comprising:
an input unit configured to receive a usage command for digital rights management (DRM) content;
a display unit configured to display advertisement content included in the DRM content when the usage command is input; and
a controller configured to update advertisement content usage state information depending on the usage command, compare the updated advertisement content usage state information with policy information regarding the use of advertisement content, and adjust permission information for the digital information included in the DRM content in the license for the DRM content based on the comparison result.

6. The terminal apparatus of claim 5, wherein the policy information regarding the use of advertisement content is information defining a relationship between the advertisement content usage state information and digital content permission update information.

7. The terminal apparatus of claim 6, wherein the controller is configured to detect the digital content permission update information mapped to the updated advertisement content usage state information based on the comparison result, and use the detected digital content permission update information to adjust the permission information for digital content.

8. The terminal apparatus of claim 5, wherein the controller is configured to control the display unit to display the digital content by using the license for the DRM content when the use of advertisement content included in the DRM is completed.
